(19) United States
(12) Patent Application Publication
(10) Pub. No.: US 2026/0003129 A1
(43) Pub. Date: Jan. 1, 2026

(54) OPTICAL ARRAY WITH SELF-ALIGNED COLLIMATED FIBERS AND MEMS MIRRORS

(71) Applicant: Omnitron Sensors, Los Angeles, CA (US)

(72) Inventor: Trent Huang, Los Angeles, CA (US)

(21) Appl. No.: 18/760,934

(22) Filed: Jul. 1, 2024

(51) Int. Cl. G02B 6/35

(52) U.S. Cl. CPC G02B 6/3518; G02B 6/3546; G02B 6/3582

(57) ABSTRACT

An optical switching array having multiple cells of MEMs optical switching units and methods of fabricating the array is disclosed. The switching unit includes a spacer structure having an enclosed light cavity. The light cavity is defined by a first end structure, a second end structure, and side structures each attached between the first and second end structure. A first input optical fiber array is attached to a top surface over the light cavity in proximity to the first end structure. A first mirror array is attached to a bottom surface over the light cavity in proximity to the first end structure. A second mirror array is attached to the top surface over the light cavity in proximity to the second end structure. An output optical fiber array is attached to the bottom surface over the light cavity in proximity to the second end structure.

### TECHNICAL FIELD

The present disclosure relates generally to MEMS structures. More particularly, aspects of this disclosure relate to a self-aligned collimated fiber array and MEMS mirror structure for optical applications.

### BACKGROUND

Micro-electromechanical systems (MEMS) are microscopic devices incorporating both electronic devices and physical moving parts. A typical MEMS device is fabricated using integrated circuit techniques on a silicon wafer or wafers. The fabrication process creates the physical moving parts from fabricating different materials that may be deposited and etched on the substrate wafer.

MEMS have numerous applications such as in microphones, sensors, accelerometers, light detection and ranging (LIDAR) systems, and optical arrays for applications such as optical communication systems. MEMS fabrication is intrinsically two dimensional to create physical structures such as mirrors on a substrate. In optical communication systems, optical signals in arrays of fibers are deflected by mirrors in optical switching devices.

An optical switch used in communication systems is a switching device that couples light beams from an input fiber to an output fiber. Typically, the light beams from an input optical fiber array are collimated and directed toward a desired location such as an output fiber array. A movable mirror in a switch mirror array redirects light beams to desired locations. A common way of moving the mirror is by electrostatic actuation using electrodes, which are positioned below the mirror. A voltage is applied to the electrodes that creates an electric field, which causes the mirror to pivot. To address and control each individual mirror in a switch mirror array, a large number of electrical connections is required to provide voltage to the electrodes.

This arrangement of optical arrays and mirror arrays used in optical communication systems present several challenges. It is desirable for an optical assembly to have three dimensional structures for multichannel optical switch application with very high port count. Such assembly structures require ultra-compact design with extremely high levels of integration. Current systems require that all components are mounted on precision-machined fixtures. Thus, the mirror components require active alignment of multiple parts with many degrees of freedom. The assembly and initial calibration of the optical arrays and the mirrors in the mirror arrays is very complex and time-consuming. Hermetic seals of the mirrors require separate sealing devices which add to process complexity and reduce optical performance.

Thus, there is a need for a MEMS based optical switch having mirror arrays and optical fiber arrays that are self-contained and initially self-aligned. There is a further need for a MEMS based optical switch that allows a compact structure for mirrors and fiber optic arrays. There is a further need for a simplified process for fabrication of a MEMS based optical switch.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter; nor is it intended to be used in isolation to determine the scope of the claimed subject matter. The subject matter should be understood by reference to appropriate portions of the entire specification of this disclosure, any or all drawings and each claim.

One disclosed example is an optical switching unit including a spacer structure having an enclosed light cavity. The light cavity is defined by a first end structure, a second end structure, and side structures each attached between the first and second end structure. The spacer structure includes a top surface surrounding the light cavity and a bottom surface surrounding the light cavity. The light cavity extends between top surface and the bottom surface. A first input optical fiber array is attached to the top surface over the light cavity in proximity to the first end structure. A first mirror array is attached to the bottom surface over the light cavity in proximity to the first end structure. The mirrors of the first mirror array are spatially aligned with optical fibers of the input optical fiber input array. A second mirror array is attached to the top surface over the light cavity in proximity to the second end structure. An output optical fiber array is attached to the bottom surface over the light cavity in proximity to the second end structure. Optical fibers of the output optical fiber array are spatially aligned with mirrors of the second mirror array.

In another disclosed implementation of the example optical switching unit, the first end structure holds a first alignment pin extending therethrough, and the second end structure holds a second alignment pin extending therethrough. The first input optical fiber array and the first mirror array each include a hole allowing the first optical fiber array and the first mirror array to be inserted on the first alignment pin. The second optical fiber array and the second mirror array each include a hole allowing the second optical fiber array and the second mirror array to be inserted on the second alignment pin. In another disclosed implementation, the input optical fiber array includes a microlens structure to collimate light signals from the fiber. The output optical fiber array includes a microlens structure to collimate light signals from the fibers. In another disclosed implementation, the input optical fiber array includes a support structure, an anchor structure, and a spring coupling the support structure to the anchor structure. An optical fiber is inserted between the support structure and the anchor structure and the spring allows the support structure to move to allow the optical fiber to be inserted. In another disclosed implementation, the optical switching unit is one of a plurality of optical switching units comprising an optical switching array. In another disclosed implementation, the first mirror array includes actuators each coupled to a corresponding mirror, each of the actuators is configured to move the mirrors to deflect a light beam from the spatially aligned optical fiber of the first optical fiber array to one of the mirrors of the second mirror array. In another disclosed implementation, the actuators are one of an electrostatic, electromagnetic, piezoelectric, or electrothermal driver. In another disclosed implementation, the second mirror array includes actuators each coupled to a corresponding mirror, each of the actuators is configured to move the mirrors to deflect a light beam from a mirror of the first mirror array to one of the optical fibers of the second optical fiber array. In another disclosed implementation, the example optical switching unit of claim 1 includes a top cross support joining the side structures. The top cross support defines one end of a first aperture and one end of a second aperture in the top surface. A bottom cross support joins the side structures. The bottom cross support defines an opposite end of the first aperture and an opposite end of the second aperture in the bottom surface.

Another disclosed example is a method of fabricating an optical switch that includes forming a spacer structure having a first end structure, a second end structure, and side structures from a substrate. The first end structure, second end structure, and side structures define a top surface and a bottom surface and an enclosed light cavity. A first mirror array is attached to the bottom surface to partially cover the light cavity. A first input optical fiber array is attached to the top surface to partially cover the light cavity. The fibers of the input fiber array are spatially aligned to mirrors of the first mirror array. A second mirror array is attached to the top surface to partially cover the light cavity. A second output optical fiber array is attached to the bottom surface to partially cover the light cavity. Fibers of the second output optical fiber array are spatially aligned to mirrors of the second mirror array.

In another disclosed implementation of the example method, the method includes attaching a microlens structure to a substrate including optical fibers to form the input optical fiber array. A microlens structure is attached to a substrate including optical fibers to form the output optical fiber array. In another disclosed implementation, the method includes forming the input optical fiber array by forming a support structure, an anchor structure, and a spring coupling the support structure to the anchor structure, and inserting an optical fiber between the support structure and the anchor structure. In another disclosed implementation, the method includes attaching a first alignment pin extending through the first end structure and attaching a second alignment pin extending through the second end structure. Attaching the first mirror array includes inserting a hole of the first mirror array over the first alignment pin. Attaching the first input optical fiber array includes inserting a hole of the first input fiber array over the first alignment pin. Attaching the second mirror array includes inserting a hole of the second mirror array over the second alignment pin. Attaching the second output fiber array includes inserting a hole of the second output fiber array over the second alignment pin. In another disclosed implementation, the method includes positioning the first mirror array on the top surface or positioning the first input fiber array on the top surface to align the mirrors of the first mirror array to the fibers of the first input fiber array after the first input fiber array or the first mirror array is attached. The method also includes positioning the second mirror array on the top surface after the first mirror array is attached to align the mirrors of the first mirror array to the mirrors of the second mirror array. The method also includes positioning the second output fiber array after the second mirror array is attached to align the mirrors of the second mirror array to the fibers of the second output fiber array. In another disclosed implementation, the mirrors of the first and second mirror arrays are set at a pre-determined angle prior to the attaching. In another disclosed implementation, the positioning of the first and second mirror arrays and the is performed by a manipulator tool based on a strength of a light signal input through two of the fibers of the input fiber array. In another disclosed implementation, the optical switching unit is one of a plurality of optical switching units comprising an optical switching array. The fabricating the spacer structure is performed simultaneously for each of the plurality of optical switching units. In another disclosed implementation, the first mirror array includes actuators each coupled to a corresponding mirror. Each of the actuators are configured to move the mirrors to deflect a light beam from the spatially aligned optical fiber of the first optical fiber array to one of the mirrors of the second mirror array. In another disclosed implementation, the actuators are one of an electrostatic, electromagnetic, piezoelectric, or electrothermal driver. In another disclosed implementation, the second mirror array includes actuators each coupled to a corresponding mirror. Each of the actuators are configured to move the mirrors to deflect a light beam from a mirror of the first mirror array to one of the optical fibers of the second optical fiber array.

### BRIEF DESCRIPTION OF THE DRAWINGS

The disclosure will be better understood from the following description of exemplary embodiments together with reference to the accompanying drawings, in which:

FIG. 1A is a perspective view of an example optical cross-connect structure with arrays of optical fibers and multiple MEMS mirrors;

FIG. 1B is a close up perspective view of one optical fiber connection units of the example array structure in FIG. 1A;

FIG. 2A is a cutaway view of one of the optical fiber connection units of the optical array structure in FIGS. 1A-1B;

FIG. 2B is a top view of the optical fiber connection unit in FIG. 2A;

FIG. 2C is a bottom view of the optical fiber connection unit in FIG. 2A;

FIG. 3 is a cross-section view of an example collimated optical fiber array in FIG. 1A;

FIGS. 4A-4D are cross-sectional views of the process of assembling the collimated optical fiber array in FIG. 3;

FIG. 5A is a side view of the initial fabrication assembly of the cell in FIG. 1;

FIG. 5B is a side view of the fabrication assembly of the cell in FIG. 1 with one of the mirror arrays being assembled;

FIG. 5C is a side view of the fabrication assembly of the cell in FIG. 1 with the input fiber array assembled;

FIG. 5D is a side view of the fabrication assembly of the cell in FIG. 1 with another of the mirror arrays being assembled;

FIG. 5E is a side view of the fabrication assembly of the cell in FIG. 1 with the output fiber array being assembled;

FIG. 6A is a top view of the positioning of the mirrors in the mirror arrays in FIG. 1A; and

FIG. 6B is a side view of the positioning of the mirror arrays in FIG. 1.

The present disclosure is susceptible to various modifications and alternative forms. Some representative embodiments have been shown by way of example in the drawings and will be described in detail herein. It should be understood, however, that the invention is not intended to be limited to the particular forms disclosed. Rather, the disclosure is to cover all modifications, equivalents, and alternatives falling within the spirit and scope of the invention as defined by the appended claims.

### Detailed Description of the Illustrated Embodiments

The present inventions can be embodied in many different forms. Representative embodiments are shown in the drawings, and will herein be described in detail. The present disclosure is an example or illustration of the principles of the present disclosure, and is not intended to limit the broad aspects of the disclosure to the embodiments illustrated. To that extent, elements and limitations that are disclosed, for example, in the Abstract, Summary, and Detailed Description sections, but not explicitly set forth in the claims, should not be incorporated into the claims, singly or collectively, by implication, inference, or otherwise. For purposes of the present detailed description, unless specifically disclaimed, the singular includes the plural and vice versa; and the word “including” means “including without limitation.” Moreover, words of approximation, such as “about,” “almost,” “substantially,” “approximately,” and the like, can be used herein to mean “at,” “near,” or “nearly at,” or “within 3-5% of,” or “within acceptable manufacturing tolerances,” or any logical combination thereof, for example.

The present disclosure is directed toward MEMS optical switch structure for an optical communication system. The unique 3D design/construction of the example optical switch structure may be used for multichannel optical switch applications with very high port count. The example assembly structure is an ultra-compact design with extremely high levels of integration of optical fiber arrays and mirror arrays.

The example optical switch structure includes individual units of optical fiber arrays and MEMS mirrors. Each unit has an enclosed light cavity that allows for hermeticity and reduced number of reflective surfaces for enhanced optical performance of the mirrors and optical fibers in directed optical signals. The example array structure allows vertical alignment between the fiber arrays and the mirror arrays. The example structure also includes flat alignment surfaces for cheap, fast, and batch alignment procedures. The dimensions of the example structure may be selected for specific wavelengths and bandwidths.

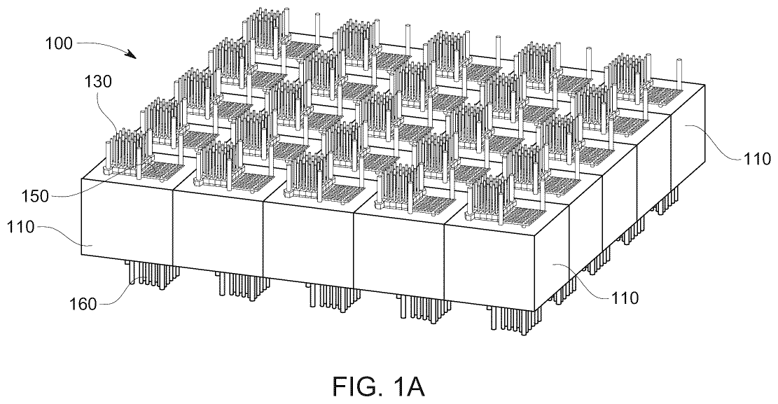

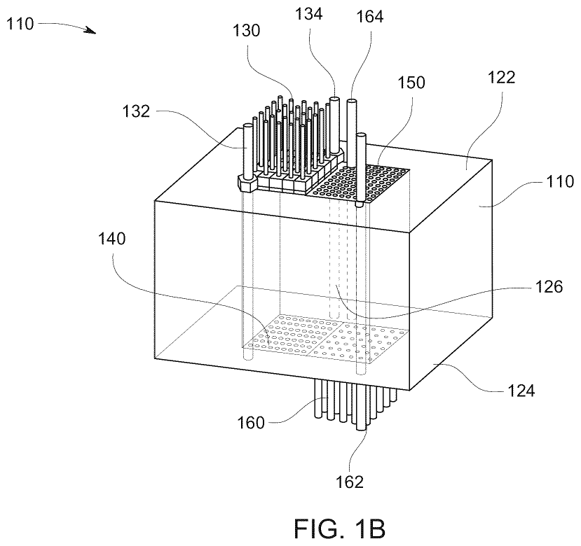

FIG. 1A is a perspective view of an example micro-electromechanical system (MEMS) based optical switching array device 100. The MEMS optical switching array device 100 is fabricated on a substrate with microstructures for optical switching as will be explained. The device 100 includes a series of optical cross-connect switching units 110 that each allow direction of optical signals. In this example, the optical switching array device 100 has 25 optical switching units 110 that are arranged in a 5×5 array. Of course, the principles described herein may be applied to fabricate in different sized optical switching arrays.

In this example, each of the optical cross-connect array units 110 includes a rectangular substrate spacer structure body 120. The substrate spacer body 120 has a top surface 122 and a bottom surface 124. The substrate spacer body 120 defines an enclosed interior light cavity 126 that is formed in the center of the body 120. A collimated input optical fiber array 130 is formed on the top surface 122. The top surface 122 surrounds the light cavity. The input optical fiber light array 130 is attached to the top surface 122 over the light cavity 126 to partially enclose the light cavity 126. The input optical fiber array 130 is initially inserted on a two alignment pins 132 and 134 that are supported by the edges of the body 120 that form the light cavity 126. Optical signals are input through the collimated input optical fiber array 130 to the isolated interior area of the light cavity 126 formed in the substrate spacer body 120. The optical signals input to the input optical fiber array 130 are directed toward a first MEMS mirror array 140 that is attached on the bottom surface 124. The bottom surface 124 surrounds the light cavity 126. The first MEMS mirror array 140 is attached to the bottom surface 124 over the light cavity 126 to partially enclose the light cavity 126. The optical signals are directed by the first MEMS mirror array 140 to a second MEMS mirror array 150 that is attached to the top surface 122. The second MEMS mirror array 150 is attached to the top surface 122 over the light cavity 126 to partially enclose the light cavity 126. The optical signals are reflected by the second MEMS mirror array 150 to a collimated output optical fiber array 160. The collimated output optical fiber array 160 is attached on the bottom surface 124. The second optical fiber array 160 is attached to the bottom surface 124 over the light cavity 126 to partially enclose the light cavity 126. In this example, the output optical fiber array 160 is inserted on two alignment pins 162 and 164 that positioned at opposite corners and are supported by the edges of the body 120 that form the light cavity 126. Although two alignment pins are used in this example, additional alignment pins could be used. For example, a four alignment pin structure with alignment pins at each corner could be used. Additional pins could be used at the sides as well. Each of the mirrors on the mirror arrays 140 and 150 may be actuated to direct light signals from corresponding optical fibers on the input fiber array 130 to any of the optical fibers of the output fiber array 160.

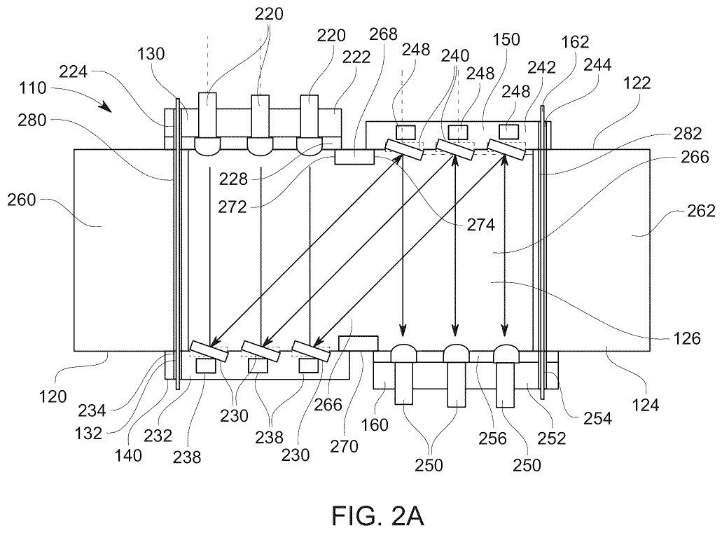

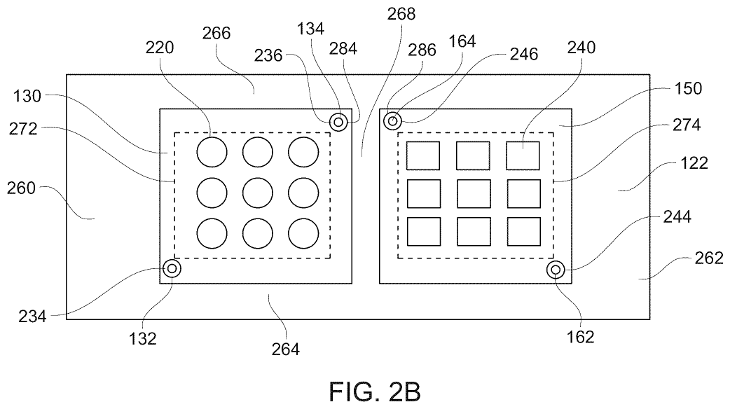

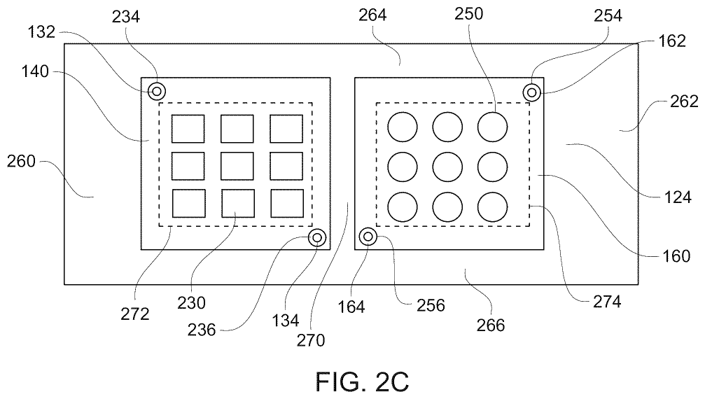

FIG. 2A is a cross section view of one of the optical cross-connect units 110. FIG. 2B is a top view of the optical cross connect unit 110. FIG. 2C is a bottom view of the optical cross connect unit 110. As shown in FIGS. 2A-2C, the spacer substrate body 120 includes the interior light cavity 126 that allows light signals to be deflected by the MEMS mirror arrays 140 and 150. As will be explained the substrate spacer body 120 allows the creation of the interior light cavity 126 to hermetically seal the components of the optical cross-connect unit 110. The collimated input optical fiber array 130 includes a series of optical fibers 220 mounted on a base member 222. The optical fibers 220 extend through the base member 222. An alignment hole 224 extends through the base member 222 at one corner and an alignment hole 226 extends through the base member 222 at the opposite end. The optical fibers 220 are optically coupled to a microlens array structure 228 that is attached to the base member 222.

The MEMS mirror array 140 includes a series of MEMS mirrors 230 that are fabricated in a base member 232. The MEMS mirrors 230 are spatially aligned with corresponding optical fibers 220 in the optical fiber arrays. Each of the MEMS mirrors 230 may be moved at a range of set angles to deflect an optical signals from a corresponding one of the optical fibers 220 of the input optical fiber array 130. An alignment hole 234 extends through the base member 232 at one corner and an alignment hole 236 extends through the base member 232 at the opposite corner. Each of the mirrors 230 may be moved by an actuator 238 at a range of set angles at a range of set angles in two dimensions to direct light beams toward the mirrors of the mirror array 150 and thus to the optical fibers of the output fiber array 160. The actuator 238 may be any appropriate driving mechanism such as electrostatic, electromagnetic, piezoelectric, or electrothermal mechanisms. Software controlled signals may be applied to each actuator 238 to tilt the respective mirror 230 at a desired angle when the optical switching array 100 is operated. The mirrors 230 and actuators 238 may be fabricated and set at an initial angle using MEMS fabrication processes. An example of using a tether and anchor structure to set a MEMS mirror at a pre-determined angle is described in U.S. application Ser. No. 18/328,624 hereby incorporated by reference. An example of fabricating an actuator for operating a mirror to tilt in two dimensions is described in U.S. application Ser. No. 18/477,316 hereby incorporated by reference. Alternatively, the angles of the mirrors 230 may be preset using the actuators 238 during the assembly process detailed below.

The optical signals are reflected to corresponding mirrors 240 of the MEMS mirror array 150. The mirrors 240 of the mirror array 150 are in physical alignment with corresponding optical fibers of the output optical fiber array 160. The mirrors 240 of the MEMS mirror array 150 are fabricated in a base 242 to be positioned at a set angle to allow the optical signals to be deflected to the collimated output optical fiber array 160. An alignment hole 244 extends through the base member 242 at one corner and an alignment hole 246 extends through the base member 242 at the opposite corner. Similar to the mirror array 140, each of the mirrors 240 may be moved by an actuator 248 at a range of set angles in two dimensions to direct light beams toward different optical fibers of the output fiber array 160. Software controlled signals may be applied to each actuator 248 to tilt the respective mirror 240 at a desired angle when the optical array is operated.

The collimated output optical fiber array 160 supports optical fibers 250 that extend through a base 252. The ends of the optical fibers 250 are aligned with respective mirrors 240 of the MEMS mirror array 150. An alignment hole 254 extends through the base member 252 at one corner and an alignment hole 256 extends through the base member 252 at the opposite end. The output light signals to the optical fibers 250 are directed via a microlens array structure 258 that is attached to one surface of the base 252.

In this example, the spacer structure 120 for the optical cross-connect unit 110 is manufactured from materials that may be microfabricated. The spacer structure 120 is ideally a single piece, which may be made fabricated from single crystal silicon, stainless steel or any other materials that can be well polished and fabricated with precision. One advantage with silicon or other semiconductor materials, is the ability to use wafer/chip bonding techniques that are commonly used in MEMS to form a hermetical seal.

The arrays 130, 140, 150, and 160 may be based on fabricating an anchor substrate. In this example, the anchor substrate is formed from a silicon wafer and the structures are formed from the silicon and polycrystalline materials such as polysilicon with various deposited metals. Thus, the structures such as the mirrors 230 and 240 herein may be formed from single crystal materials (e.g., Si, GaAs, InP); polycrystalline materials such as polysilicon, metals such as electroplated Ni, Cu, Au, and polymers, such as polyimides, epoxies (e.g., SU8), and PMGI.

The example optical switching units 110 in FIG. 1 have a wavelength/bandwidth agnostic design. The input optical fiber array 130 and the mirror array 140 are attached to the respective top surface 122 and bottom surface 124 in proximity to an end structure 260. The arrays 130 and 140 thus enclose roughly half of the light cavity 126. The output optical fiber array 160 and mirror array 150, are attached to the respective top surface 122 and bottom surface 124 in proximity to an end structure 262. The end structure 260 and 262 are connected by side structures 264 and 266 to define the area of the light cavity 126. The structures 260, 262, 264 and 266 form the sides of the light cavity 126. A top cross structure 268 joins the side structures 264 and 266. A bottom cross structure 270 also joins the side structures 264 and 266. Thus, the top surface 122 is defined by the top surfaces of the structures 260, 262, 264 and 266 and top cross structure 268. The bottom surface 124 is defined by the bottom surfaces of the structures 260, 262, 264 and 266 and bottom cross structure 270. An aperture 272 is defined by edges of the end spacer structure 260, side structures 264 and 266, and cross structures 268 and 270. Another aperture 274 is defined by edges of the end spacer structure 262, side structures 264 and 266, and cross structures 268 and 270. The apertures 272 and 274 thus extend between the top surface 124 and the bottom surface 124. Thus, the input optical fiber array 130 is attached to the top surface 122 at the edges of the spacer structure 260, the side structures 264 and 266, and the cross structure 268 to cover one end of the aperture 272. The mirror array 140 is attached to the bottom surface 124 at the edges of the spacer structure 260 and the side structures 264 and 266 to cover the other end of the aperture 272. Correspondingly, the mirror array 150 is attached to the top surface 122 at the edges of the spacer structure 262 and the side structures 264 and 266 to cover one end of the aperture 274. The output optical fiber array 160 is attached to the bottom surface 124 at the edges of the spacer structure 262 and the side structures 264 and 266 to cover the other end of the aperture 274.

Each of the end structures 260 and 262 include corresponding alignment holes 280 and 282 that extend from the top surface 122 to the bottom surface 124. The side structure 266 includes corresponding alignment holes 284 and 286 that extend from the top surface 122 to the bottom surface 124. The alignment pin 132 is inserted through the alignment hole 234 in the input fiber array 130, the alignment hole 280 in the spacer structure 260, and the alignment hole 244 in the mirror array 140. The alignment pin 134 is inserted through the alignment hole 236 in the input fiber array 130, the alignment hole 284 in the side structure 266, and the alignment hole 246 in the mirror array 140. The alignment pins 132 and 134 and respective alignment holes allow alignment of the input fiber array 130 to the mirror array 140.

The alignment pin 162 is inserted through the alignment hole 254 in the mirror array 150, the alignment hole 282 in the spacer structure 262, and the alignment hole 254 in the output fiber array 160. The alignment pin 164 is inserted through the alignment hole 256 in the mirror array 150, the alignment hole 286 in the side structure 266, and the alignment hole 256 in the output fiber array 160. The alignment pins 162 and 164 and respective alignment holes allow alignment of the output optical fiber array 160 to the mirror array 150. The apertures 272 and 274 that are formed accommodate movement of respective mirrors 230 and 240 by the actuators 238 and 248. The top surface 122 formed by the end spacer structures 260 and 262, side structures 264 and 266 and cross structure 268 is fabricated to be as flat as possible to aid in alignment of the input optical fiber array 130 and the mirror array 150. The bottom surface 124 formed by the end spacer structures 260 and 262, side structures 264 and 266 and cross structure 270 is fabricated to be as flat as possible to aid in alignment of the output optical fiber array 160 and the mirror array 140.

The end structures 260 and 262 and side structures 264 and 266 are used to define the total lengths of the light paths in the optical cross connect unit 110. The top surface 122 and the bottom surface 124 provide flat bonding surfaces for the optical fiber arrays 130 and 160 and mirror arrays 140 and 150 around the apertures 272 and 274. The holes 280 and 282 in the end structures 260 and 262 and the holes 284 and 286 in side structure 266, once sealed, provide encapsulation for all moving parts and the entire light path between the input fiber array 130 and the output fiber array 160. The sealing is accomplished by the end structures 260 and 262, and side structures 264 and 266 being enclosed by the input fiber array 130, mirror arrays 140 and 150, and the output fiber array 160 that cover the apertures 272 and 274.

In this example, the optical fibers 220 are centered in prefabricated holes in the input optical fiber array 130 by using a self-centering mechanism. The optical fibers 220 allow the collimation of the light as it exits the input fiber array 130 and enters the interior light cavity 126. The input optical fiber array 130 has matching lateral pitches as the mirrors 230 on the corresponding mirror array 140.

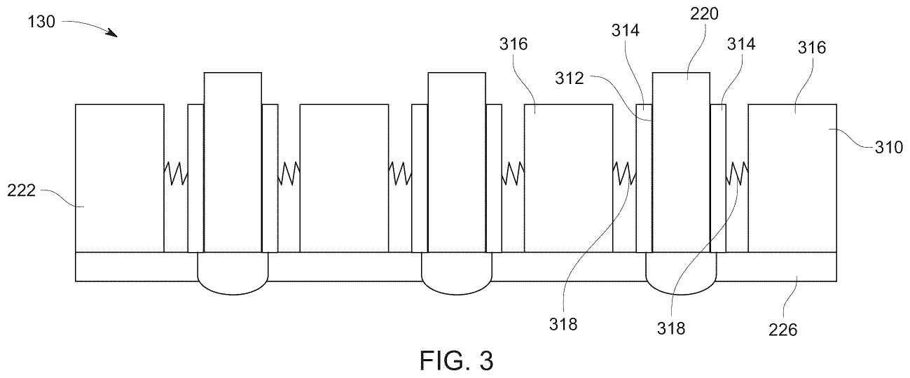

FIG. 3 shows a mechanical diagram of one of the optical arrays such as the input optical fiber array 130. In this example, the input optical fiber array 130 is a MEMS structure that allows initial flexible positioning of the optical fibers 220. The optical fiber array 130 includes structures that form the base 222, which provides accurate assembly of the optical fibers 220. The structures of the optical fiber array 130 forming the base 222 are fabricated from a substrate 310. Holes 312 in the substrate 310 provide coarse positioning for each of the optical fibers 220 that are inserted in the respective holes 312. Play is required to allow for assembly operations, therefore enhancing positioning accuracy. Each of the holes 312 are created between different optical fiber support structures 314. The optical fiber support structures 314 are free-moving and coupled to anchor structures 316 with flexible springs 318 that may be flexible tethers. The support structure 314 and anchor structures 316 are fabricated from the substrate 310. This creates a self-centering spring-loaded mechanism that provides additional accuracy for positioning the optical fibers 220. Glue/epoxy may be applied on the sides of the optical fibers 220 to fix the optical fibers 220 in position after alignment. Alternatively, the input optical fiber array 130 may be fabricated so the optical fibers are initially fixed thus eliminating the support structures and springs.

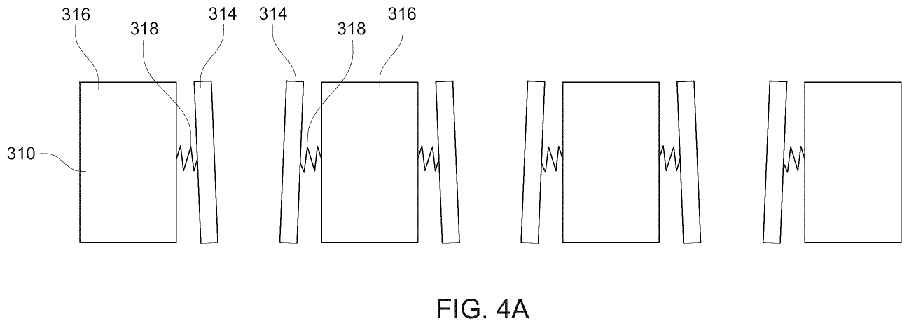

FIGS. 4A-4D show a sequence of assembling the input optical fiber array 130 in FIG. 3. In this example, the substrate 310 may be made of any flat, machined samples, e.g., semiconductor wafers, such as silicon, or stainless steel, aluminum, or alloys. FIG. 4A shows the fabrication of the springs 318, and receptacles formed between the support structures 314 and the anchor structure 316 in the substrate. These structures may be fabricated in the same processing step of the substrate 310. The fabrication process for forming the springs 318 and support structures 314 and 316 may be based on chemical or plasma etching, machining, laser etching or electrical discharge machining (EDM). Of course other suitable fabrication methods may be used to create the springs 318 and the structures 314 and 316.

After the initial fabrication, the optical fibers 220 are inserted between the support structures 314 as shown in FIG. 4B. The springs 318 attached to the support structures 314 allow the structures 314 to be tilted in response to the optical fibers 220 inserted between the structures 314. The tilted surfaces of the support structure 314 help facilitate/accommodate operator/placement errors of the optical fibers 220.

FIG. 4C shows the full insertion of the optical fibers 220 within the support structures 314 and 316. The holes 312 created by the support structures 314 are in full contact with the sidewall of the optical fibers 220. The optical fibers 220 slightly protrude through the top surface of the substrate 310. The springs 318 provide a self-centering restoring force for the optical fibers 220 by providing spring force to the support structures 314 relative to the anchor structures 316.

FIG. 4D shows the addition of the microlens array structure 228 to the support structures 314 and the anchor structures 316. Any suitable bonding process may be used for attaching the microlens array structure 228 such as a fusion bond, an anodic bond, an adhesive bond and the like. In addition, anti-reflective (AR) coatings may be added on the lens surface of the microlens of the microlens structure 228 to reduce reflection. In this example, the microlens array structure 228 consists of an array of collimating microlenses that correspond to the ends of the optical fibers 220. The example input optical fiber array 130 avoids needing adhesives in the optical path of the optical fibers 220. Complete adhesive-less optical paths requires absence of adhesives between fibers and lenses. This can be achieved by polishing the ends of the fibers, ensuring flatness before pushing the fibers up against the top surfaces of the lens array and applying glue around the fibers. The microlens structure 228 is fabricated with an array of collimating microlenses that are wafer bonded and separated into separate structures such as the microlens structure 228.

A typical assembly procedure may start with the insertion of the optical fibers 220 into the MEMS centering chip. The ends of the optical fibers 220 are polished, ensuring that the top surface is flush with the silicon structures, or protruding slightly (by nms, controllable via chemical-mechanical planarization (CMP)). Then either direct wafer bonding between glass and silicon is performed or a thin layer of glue/epoxy in areas surrounding the optical fibers 220 and the corresponding microlenses of the microlens array for the attachment of the optical fibers 220 to the microlens of the microlens structure 228. Epoxy or adhesive may be added to the spring area to help fix the springs 318 before chemical-mechanical planarization (CMP).

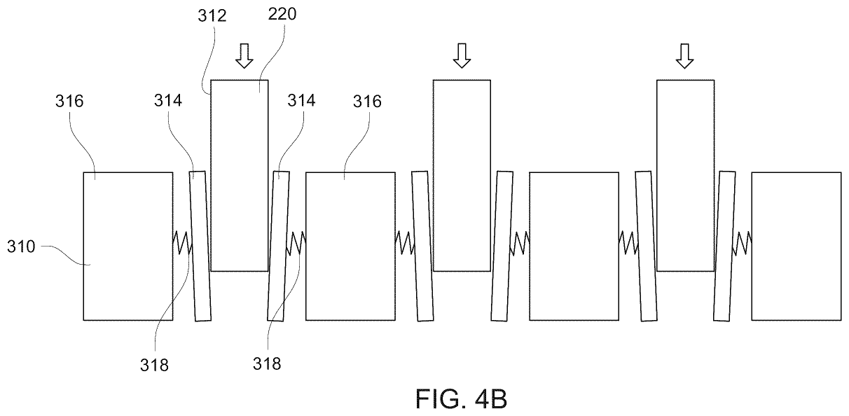

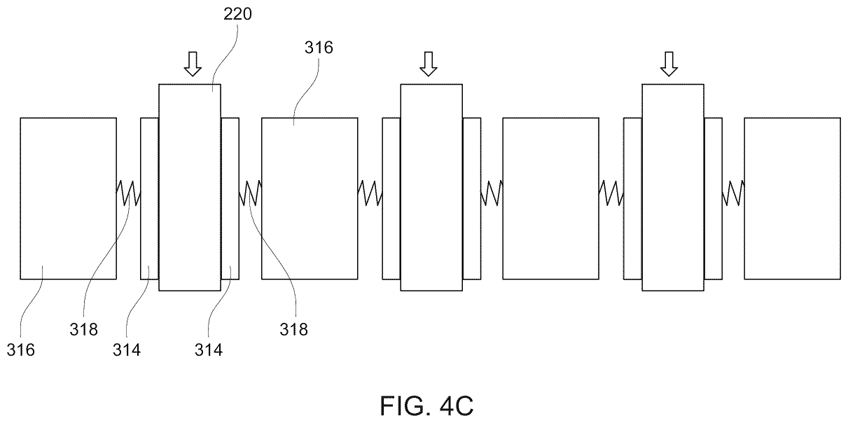

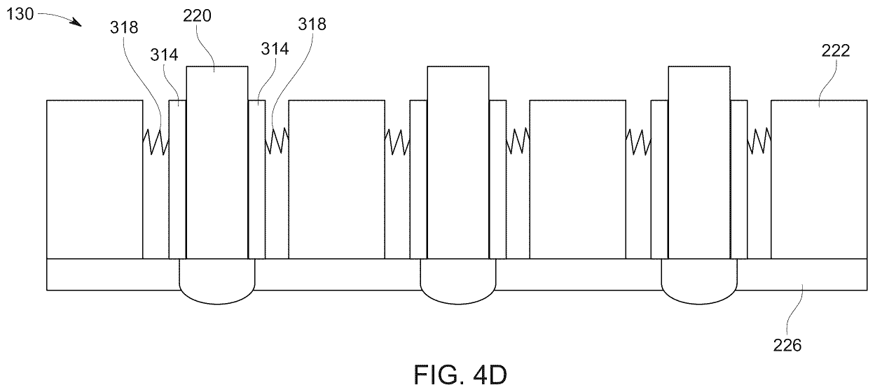

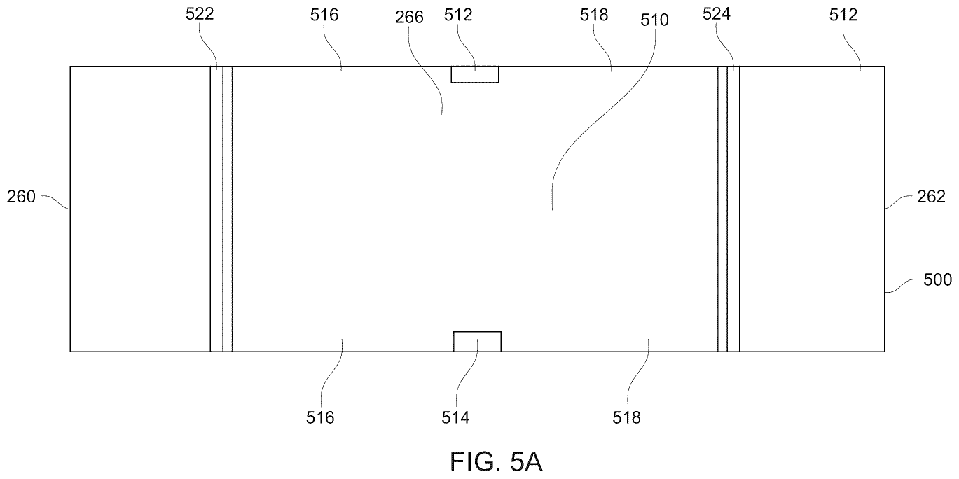

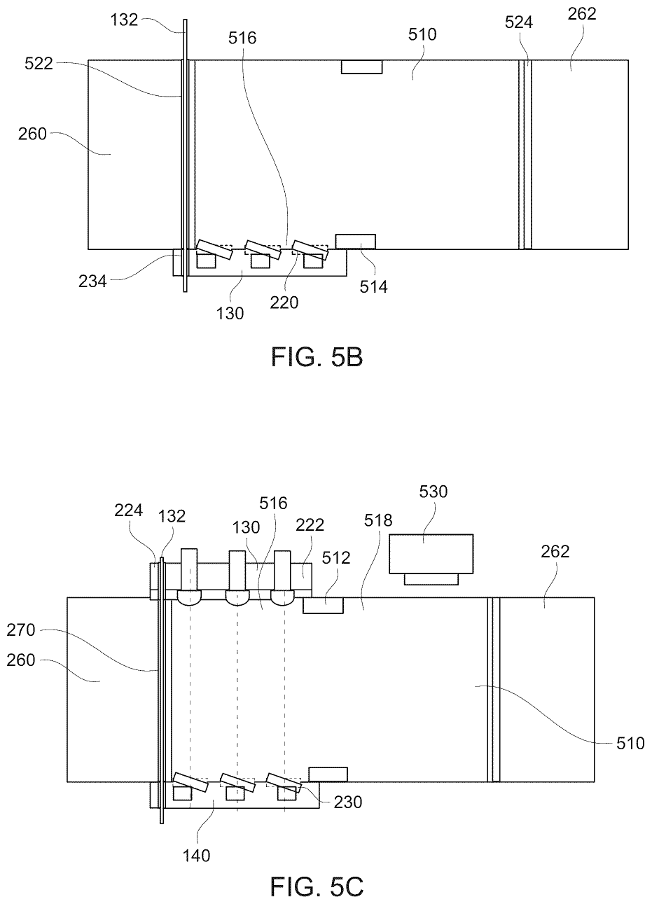

FIG. 5A shows the assembly and fabrication of the structure of the optical cross connect unit 110. All of the optical cross-connect switching units 110 in the array such as the optical switching array device 100 in FIG. 1 may be fabricated in parallel in processing a substrate. An initial substrate 500 is created. The substrate 500 may be made out of many materials (e.g., semiconductors such as silicon, metals such as aluminum, or alloys such as stainless steel), as long as the front and back surfaces are well polished and holes can be drilled/cut through the substrate 500. A cavity 510 is created in the substrate 500 to define the two end structures 260 and 262 and the side structures 266 and 268 in FIGS. 2A-2C. Top layer cross structure 512 and bottom layer cross structure 514 are created to span the cavity 510 and define apertures 516 and 518 to support the fiber optics arrays 130 and 160 and the mirror arrays 140 and 150. The enclosed cavity 510 allows light transmission in a sealed environment to helps minimize the chance of external disturbances, such as moisture, and dust particles, from interfering with the light signal and to ensure long term reliability, which is especially important for the moving parts in the MEMS mirror arrays. Holes 522 and 524 may be drilled, etched, lasered or machined in the end structures 260 and 262. The alignment holes 522 and 524 need to have precision positioning relative to the edges of the end structure 260 and 262. The walls of the switch cavity 510 defined by the sides of the end structures 260 and 262 do not have to be straight or smooth.

FIG. 5B shows the assembly of the MEMS mirror array 140 to the end structure 260 of the substrate body 500. The alignment pin 132 is inserted through the alignment hole 522 of the end structure 260 and through the alignment hole 234 in the mirror array 140. The other alignment pin 134 in FIG. 2B-2C is also inserted through the corresponding holes in the side structure 266 and the mirror array 140. The MEMS mirror array 140 thus covers one end of the aperture 516. The MEMS mirror array 140 is then bonded onto the bottom edge surfaces surrounding the bottom end of the aperture 516. The process may be extended to fabricate the units such as the unit 110 at the wafer-level followed by die singulation for separate complete arrays. Thus, a wafer with many mirror arrays and a wafer/or large plate of many spacer structures may be joined and then separated into different array units, each containing a set of mirror arrays and spacer structures.

FIG. 5C shows the assembly of the input optical fiber array 130 to the optical cross connect unit 110. The fiber array 130 is aligned to the top surface of the end structure 260. Coarse alignment is achieved by the alignment pin 132 being inserted in the alignment hole 234 and the alignment pin 134 (not shown) being inserted in the alignment hole 236 on the fiber array 130. The fiber array 130 thus rests on the edges of the top surface surrounding the aperture 516 to cover the other end of the aperture 516. The fiber array 130 and mirror array 140 are precisely aligned on two fibers usually on opposite corners of fiber array 130 to the corresponding two mirrors of the mirror array 140. An active alignment process may be used to position the fiber array 130. For example, a light signal may be emitted through opposite corner fibers and a camera 530 may be placed over the aperture 518 to capture the light from the opposite corner mirrors of the mirror array 140. A manipulator tool may be used to adjust the position of the fiber array 130 to maximize the light outputs from the mirrors of the mirror array 140 as captured by the camera 530. Once light output is maximized, the fiber array 130 may be attached in the position via any suitable bonding technique. In this example, one element such as either the fiber array or the mirror array, is fixed. In the case where the fiber array is fixed, the mirror array is moved slowly until perfect alignment is achieved before fixing the final alignment. One of the advantages of using arrays in such alignment is that only two mirror/optical fibers that are far from each other in the respective arrays need be aligned and all the other fiber and mirror elements should be aligned.

FIG. 5D shows the alignment and bonding of the mirror array 150. The mirror array 150 is positioned on the top edges surrounding the aperture 518 to cover the aperture 518. Coarse alignment occurs by inserting the alignment hole 244 in the base member 242 of the mirror array 150 on the alignment pin 162 and the alignment hole 246 on the alignment pin 164 (not shown). The mirror arrays 140 and 150 are then accurately aligned via light signals reflected from two mirrors usually on opposite corners of the respective mirror arrays 140 and 150. The position of the mirror array 150 relative to the aperture 518 is adjusted to align the mirrors on opposite corners to the respective mirrors of the mirror array 140. This process may use any suitable active alignment process such as using the camera 530 to determine the position of the mirror array 150 that results in maximum output of light signals from opposite optical fibers that are reflected from the corresponding mirrors in the array 150. Once aligned, the mirror array 150 is fixed in the aligned position over the aperture 518 by any suitable bonding technique.

In this example, the pre-set angles in the mirrors of the mirror arrays 140 and 150 vary depending on design. The example design of the mirror arrays 140 and 150 have the corresponding mirrors at preset initial angles, thus requiring only the positioning of the entire mirror arrays to achieve the final alignment of individual mirrors with corresponding optical fibers of the fiber arrays 130 and 160. Of course, the actuators on the mirror arrays 140 and 150 may be used to adjust the mirrors to the present initial angles during the assembly process.

FIG. 5E shows the installation of the output optical fiber array 160 over the other end of the aperture 518. The alignment of the optical array 160 to the existing assembly is performed in this setup. The optical array 160 is installed through coarse alignment of the hole 254 of the base member 252 with the alignment pin 162 and the hole 256 of the base member 252 with the alignment pin 164 (not shown). The optical array 160 thus rests on the edges surrounding the bottom end of the aperture 518. The position of the optical array 160 is then adjusted to accurately align the optical fibers 250 on opposite corners of the optical array 160 with the corresponding opposite two mirrors on opposite corners of mirror array 150. A similar active alignment process may be used with a camera 530 capturing image outputs from fibers on opposite ends of the optical fiber array 160. Once aligned, the optical array 160 is fixed in the aligned position by any suitable bonding technique.

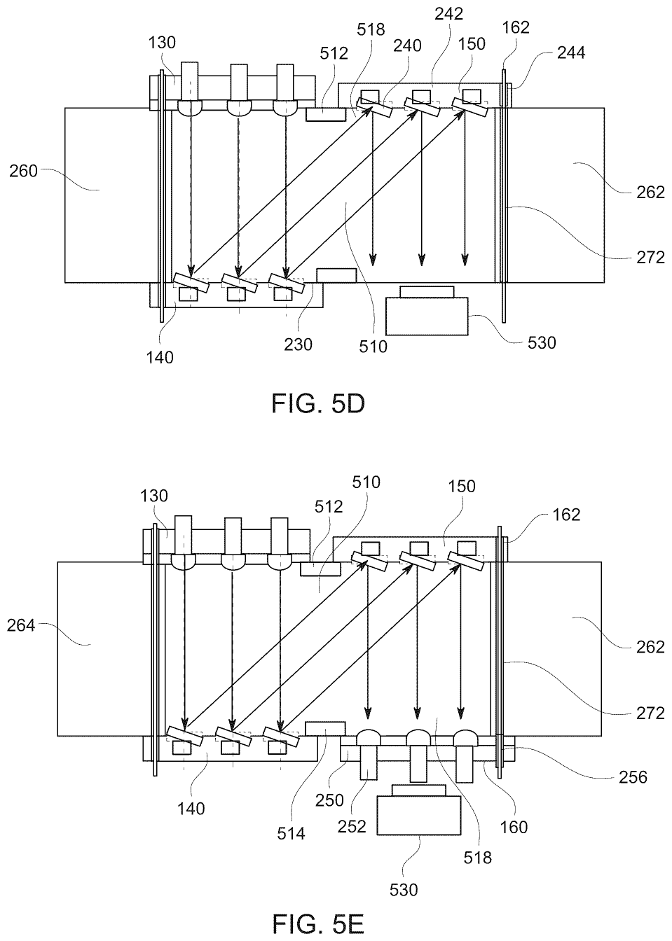

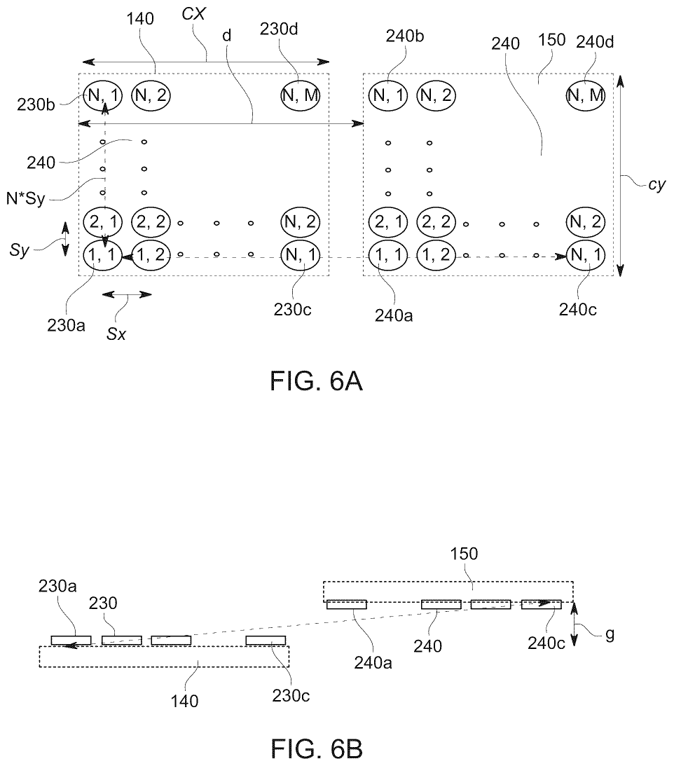

FIG. 6 shows a top view of the layout of example mirrors 230 on the mirror array 140 and corresponding mirrors 240 on the mirror array 150. FIG. 6 also shows a side view of the mirror array 140 and the mirror array 150. The mirrors 230 and 240 in respective arrays 140 and 150 are defined by x and y directions. In this example, Sₓ and S_{y} are pitches in the x direction and the y direction between respective mirrors such as the mirrors 230 in the mirror array 140. M is the number of devices in array in the x direction, N is the number of devices in the array in the y direction. Thus, the total number of mirrors in each array 140 and 150 is M×N. For example, in the mirror array 140, a first column of mirrors includes a first mirror 230a to a Nth mirror 230b. A last column of mirrors includes a first mirror 230c and a Nth mirror 230d. The first mirror 230a also defines a first row of M mirrors that ends in the Mth mirror 230c. A last row of mirrors is defined by a first mirror 230b and a Mth mirror 230d. Correspondingly, in the mirror array 150, a first column of mirrors includes a first mirror 240a to a Nth mirror 240b. A last column of mirrors includes a first mirror 240c and a Nth mirror 240d. The first mirror 240a also defines a first row of M mirrors that ends in the Mth mirror 240c. A last row of mirrors is defined by a first mirror 240b and a Mth mirror 240d.

Cₓ and C_{y} are array dimensions in the x and y directions. g is vertical gap between top mirror array 150 and the bottom mirror array 140. Thus, g is also the thickness of the end structures 260 and 262 in FIG. 2. d is lateral pitch (the distance between the edges of the arrays 140 and 150) for placement of the arrays 140 and 150. In this example, the distance between two opposite mirrors such as the mirror 230a of the array 140 and the mirror 240c of the array 150 is defined as Sqrt[(d+M*Sₓ)²+(N*S_{y})²+g²]

Each of the mirrors 230 and 240 in the arrays 140 and 150 may be fabricated at a set tilt angle. The maximum mirror (mechanical) tilting angle (aₘₐₓ) is defined as:

$${a}_{max} = Θ / 2 = arctan ( ( d + {S}_{m} * M ) / g ) / 2 ∼ arctan ( {S}_{m} * M / g ) ;$$

$$where {S}_{f} = {S}_{m} and d ∼ M * {S}_{m} .$$

where Sₘ is the spatial pitch between mirrors in each of the arrays. Thus, in this example, Sₓ and S_{y} are equal and thus are both represented by Sₘ. For example, where there are 33 mirrors in the x direction, with a gap of 1 or 1.5 cm between the arrays, and a spatial pitch of 200 or 150 um:
If Sₘ=200 μm, M=33, g=1 cm, then aₘₐₓ=Θ/2=˜ 21.7 deg
If Sₘ=200 μm, M=33, g=1.5 cm, then aₘₐₓ=Θ/2=˜ 14.4 deg
If Sₘ=150 μm, M=33, g=1.5 cm, then aₘₐₓ=Θ/2=˜ 10.8 deg

Part of the mirror angle comes from angular offsets that are preset (aₚᵣₑ) before assembly. The actual angle (a_{act}) the mirrors need to be actuated across is:

$${a}_{act} = {a}_{max} - {a}_{p r e} = arctan ( ( d + {S}_{m} * M ) / g ) / 2 - arctan ( d / g ) / 2$$

Assuming a design with identical preset angles aₚᵣₑ,
If Sₘ=200 μm, M=33, g=1 cm, then aₚᵣₑ˜ 10.4 deg
If Sₘ=200 μm, M=33, g=1.5 cm, then aₚᵣₑ˜ 7.2 deg
If Sₘ=150 μm, M=33, g=1.5 cm, then aₚᵣₑ˜ 5.4 deg
   For an array with approximately 1000 mirrors (31×31), the maximum mirror angle needed to switch light between the most extreme relative locations in each mirror array is around 5-11 degrees.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware, generalized hardware made specialized by the execution of software thereon that enables the hardware to perform specific function, software stored on a computer-readable medium, or a combination thereof.

The terminology used herein is for the purpose of describing particular embodiments only, and is not intended to be limiting of the invention. As used herein, the singular forms “a,” “an,” and “the” are intended to include the plural forms as well, unless the context clearly indicates otherwise. Furthermore, to the extent that the terms “including,” “includes,” “having,” “has,” “with,” or variants thereof, are used in either the detailed description and/or the claims, such terms are intended to be inclusive in a manner similar to the term “comprising.”

Unless otherwise defined, all terms (including technical and scientific terms) used herein have the same meaning as commonly understood by one of ordinary skill in the art. Furthermore, terms, such as those defined in commonly used dictionaries, should be interpreted as having a meaning that is consistent with their meaning in the context of the relevant art, and will not be interpreted in an idealized or overly formal sense unless expressly so defined herein.

While various embodiments of the present invention have been described above, it should be understood that they have been presented by way of example only, and not limitation. Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application. Thus, the breadth and scope of the present invention should not be limited by any of the above described embodiments. Rather, the scope of the invention should be defined in accordance with the following claims and their equivalents.

What is claimed is:

1. An optical switching unit comprising:
a spacer structure having an enclosed light cavity defined by a first end structure, a second end structure, and side structures each attached between the first and second end structure, a top surface surrounding the light cavity, and a bottom surface surrounding the light cavity, wherein the light cavity extends between top surface and the bottom surface;
a first input optical fiber array attached to the top surface over the light cavity in proximity to the first end structure;
a first mirror array attached to the bottom surface over the light cavity in proximity to the first end structure, wherein mirrors of the first mirror array are spatially aligned with optical fibers of the input optical fiber input array;
a second mirror array attached to the top surface over the light cavity in proximity to the second end structure; and
an output optical fiber array attached to the bottom surface over the light cavity in proximity to the second end structure, wherein optical fibers of the output optical fiber array are spatially aligned with mirrors of the second mirror array.

2. The optical switching unit of claim 1, wherein the first end structure holds a first alignment pin extending therethrough, and wherein the second end structure holds a second alignment pin extending therethrough, and wherein the first input optical fiber array and the first mirror array each include a hole allowing the first optical fiber array and the first mirror array to be inserted on the first alignment pin, and wherein the second optical fiber array and the second mirror array each include a hole allowing the second optical fiber array and the second mirror array to be inserted on the second alignment pin.

3. The optical switching unit of claim 1, wherein the input optical fiber array includes a microlens structure to collimate light signals from the fibers, and wherein the output optical fiber array includes a microlens structure to collimate light signals from the optical fibers.

4. The optical switching unit of claim 1, wherein the input optical fiber array includes a support structure, an anchor structure, and a spring coupling the support structure to the anchor structure, wherein an optical fiber is inserted between the support structure and the anchor structure and the spring allows the support structure to move to allow the optical fiber to be inserted.

5. The optical switching unit of claim 1, wherein the optical switching unit is one of a plurality of optical switching units comprising an optical switching array.

6. The optical switching unit of claim 1, wherein the first mirror array includes actuators each coupled to a corresponding mirror, each of the actuators configured to move the mirrors to deflect a light beam from the spatially aligned optical fiber of the first optical fiber array to one of the mirrors of the second mirror array.

7. The optical switching unit of claim, wherein the actuators are one of an electrostatic, electromagnetic, piezoelectric, or electrothermal driver.

8. The optical switching unit of claim 1, wherein the second mirror array includes actuators each coupled to a corresponding mirror, each of the actuators configured to move the mirrors to deflect a light beam from a mirror of the first mirror array to one of the optical fibers of the second optical fiber array.

9. The optical switching unit of claim 1, further comprising:
a top cross support joining the side structures, the top cross support defining one end of a first aperture and one end of a second aperture in the top surface; and
a bottom cross support joining the side structures, the bottom cross support defining an opposite end of the first aperture and an opposite end of the second aperture in the bottom surface.

10. A method of fabricating an optical switch comprising:
forming a spacer structure having a first end structure, a second end structure, and side structures from a substrate, wherein the first end structure, second end structure, and side structures define a top surface and a bottom surface and an enclosed light cavity;
attaching a first mirror array to the bottom surface to partially cover the light cavity;
attaching a first input optical fiber array to the top surface to partially cover the light cavity, wherein fibers of the input fiber array are spatially aligned to mirrors of the first mirror array;
attaching a second mirror array to the top surface to partially cover the light cavity; and
attaching a second output optical fiber array to the bottom surface to partially cover the light cavity, wherein fibers of the second output optical fiber array are spatially aligned to mirrors of the second mirror array.

11. The method of claim 10, further comprising:
attaching a microlens structure to a substrate including optical fibers to form the input optical fiber array; and
attaching a microlens structure to a substrate including optical fibers to form the output optical fiber array.

12. The method of claim 10, further comprising forming the input optical fiber array by forming a support structure, an anchor structure, and a spring coupling the support structure to the anchor structure, and inserting an optical fiber between the support structure and the anchor structure.

13. The method of claim 10, further comprising:
attaching a first alignment pin extending through the first end structure;
attaching a second alignment pin extending through the second end structure; and
wherein attaching the first mirror array includes inserting a hole of the first mirror array over the first alignment pin; wherein attaching the first input optical fiber array includes inserting a hole of the first input fiber array over the first alignment pin; wherein attaching the second mirror array includes inserting a hole of the second mirror array over the second alignment pin; and wherein attaching the second output fiber array includes inserting a hole of the second output fiber array over the second alignment pin.

14. The method of claim 10, further comprising:
positioning the first mirror array on the top surface or positioning the first input fiber array on the top surface to align the mirrors of the first mirror array to the fibers of the first input fiber array after the first input fiber array or the first mirror array is attached; and
positioning the second mirror array on the top surface after the first mirror array is attached to align the mirrors of the first mirror array to the mirrors of the second mirror array; and
positioning the second output fiber array after the second mirror array is attached to align the mirrors of the second mirror array to the fibers of the second output fiber array.

15. The method of claim 14, wherein the mirrors of the first and second mirror arrays are set at a pre-determined angle prior to the attaching.

16. The method of claim 14, wherein the positioning of the first and second mirror arrays and the is performed by a manipulator tool based on a strength of a light signal input through two of the fibers of the input fiber array.

17. The method of claim 10, wherein the optical switching unit is one of a plurality of optical switching units comprising an optical switching array, wherein the fabricating the spacer structure is performed simultaneously for each of the plurality of optical switching units.

18. The method of claim 10, wherein the first mirror array includes actuators each coupled to a corresponding mirror, each of the actuators configured to move the mirrors to deflect a light beam from the spatially aligned optical fiber of the first optical fiber array to one of the mirrors of the second mirror array.

19. The method of claim 18, wherein the actuators are one of an electrostatic, electromagnetic, piezoelectric, or electrothermal driver.

20. The method of claim 10, wherein the second mirror array includes actuators each coupled to a corresponding mirror, each of the actuators configured to move the mirrors to deflect a light beam from a mirror of the first mirror array to one of the optical fibers of the second optical fiber array.
